(19) United States
(12) Patent Application Publication
(10) Pub. No.: US 2005/0279193 A1
(43) Pub. Date: Dec. 22, 2005

(54) Method and apparatus for facilitating removal and attachment of automobile tires

(76) Inventors: LIoyd C. Darby, Philadelphia, PA (US); William Banks, Philadelphia, PA (US)

Correspondence Address: KNOBLE YOSHIDA & DUNLEAVY LLC;Eight Penn Center, Suite 1350, 1628 John F. Kennedy Blvd., Philadelphia, PA, 19103, US

(21) Appl. No.: 11/056,019

(22) Filed: Feb. 11, 2005

Related U.S. Application Data
(60) Provisional application No. 60/580,302, filed on Jun. 17, 2004.

(51) Int. Cl. B25B 23/16

(52) U.S. Cl. 81/177.2

(57) ABSTRACT

A wrench extender that has gripping members that enable it to be attached to a lug nut wrench. The wrench extender permits a person to remove or attach lug nuts on an automobile tire without requiring that much force. The wrench extender is easily attached and removed from the lug nut wrench and is capable of being used with cruciform shaped lug nut wrenches.

### BACKGROUND OF THE INVENTION

1. Field of the Invention

The invention relates to the field of automobiles. In particular the invention relates to tools used for the changing of automobile tires.

2. Description of the Related Technology

When an automobile gets a flat tire, frequently the person changing the tire is forced to use the tool supplied by the auto manufacturer. In some events the supplied tool, or the tightness of the lug nuts on the wheel make it difficult, if not impossible, for a person to remove the nuts in order to change the tire. This is especially true for those individuals who physically do not have the required strength to loosen the lug nuts, especially those lug nuts previously secured by pneumatic wrenches.

In the past there have been some developments in the field for assisting people in the removal of nuts.

U.S. Pat. No. 2,490,739 to Nesbitt discloses an extender for a conventional wrench. Although, suitable for a conventional wrench it is not designed for wrenches used for the removal of lug nuts.

U.S. Pat. No. 4,619,161 to Reynolds discloses a support for a wheel lug wrench having a base for supporting the lug wrench. Additionally, an extender may be attached to the end of a wrench. However, the extender attaches to the end of lug wrench by having a cylindrical engagement portion slid over the handle and is designed for use with 90° angled lug wrenches.

U.S. Pat. No. 4,960,014 to Kelly discloses an extender for wrenches. However, the extender is not designed for use with lug wrenches and instead is designed for use with conventional wrenches and for pipe wrenches. These types of wrenches are not suitable for use in the well of an automobile tire rim.

U.S. Pat. No. 6,308,596 to Williams discloses a wrench extender that is capable of being used with a variety of wrenches including a lug wrench, however not specifically a cruciform shaped wrench. The extender has specially angled wedge fingers that grip the handle of a wrench. It the nature of the angle of the wedge fingers that assists in the gripping of the handle.

U.S. Pat. No. 6,662,692 to Anderson et al. discloses a lug wrench support structure and a tube-like extender for gripping a lug wrench. Although designed for use with cruciform shaped lug wrenches, the nature of the hollow extender requires that the extender be placed entirely over one end of the cruciform shaped lug wrench. The extender applies the force to only one end of the cruciform shaped wrench.

U.S. patent application No. 2004/0025649 to Rugee discloses a wrench extender that is to be used with pipe wrenches. The wrench extender is not designed for use with cruciform shaped wrenches.

The aforementioned wrench extenders all provide a person with some means for increasing the ease with which a nut is removed through the use of a wrench. However, there is no existing extender that is designed for use with a cruciform shaped lug wrench that is both versatile and easily handled.

Therefore, there exists a need for providing a lug wrench extender that is compatible with cruciform shaped lug wrenches, and is versatile and easily handled.

### SUMMARY OF THE INVENTION

Accordingly, it is an object of certain embodiments of the invention to provide a providing a lug wrench extender that is compatible with cruciform shaped lug wrenches, and is versatile and easily handled.

According to a first aspect of the invention a wrench extender is disclosed having a body member, a first gripping member attached to a body member and curved in a first direction; and a second gripping member attached to the body member and curved in a second direction, wherein the second direction is opposite of the first direction.

According to a second aspect of the invention a method for using a wrench extender is disclosed having the steps of providing a wrench extender. The wrench extender has a body member, a first gripping member attached to the body member and curved in a first direction, and a second gripping member attached to the body member and curved in a second direction, wherein the second direction is opposite of the first direction. The method includes gripping a first portion of a cruciform wrench with the first gripping member and gripping a second portion of the cruciform wrench with the second gripping member. The method also includes moving the wrench extender in either a clockwise or counterclockwise direction, wherein said step of moving said wrench extender moves said cruciform wrench.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a wrench extender.

FIG. 2 shows the wrench extender from FIG. 1 attached to a cruciform lug wrench.

FIG. 3 shows a close up view of a gripping member.

FIG. 4 shows an embodiment of a wrench extender that is foldable.

FIG. 5 shows an embodiment of a wrench extender that is in two parts and is capable of being screwed together.

FIG. 6 shows an embodiment of a wrench extender that is telescopically folded.

FIG. 7 shows an embodiment of a wrench extender that has a snap securement mechanism.

FIG. 8 shows an embodiment of a wrench extender wherein the handle portion is screwed into the gripping portion.

FIG. 9 shows an embodiment of a wrench extender with an angled handle.

FIG. 10 shows a close up view of gripping member with an optional gripping surface.

### DETAILED DESCRIPTION OF THE PREFERRED EMBODIMENT(S)

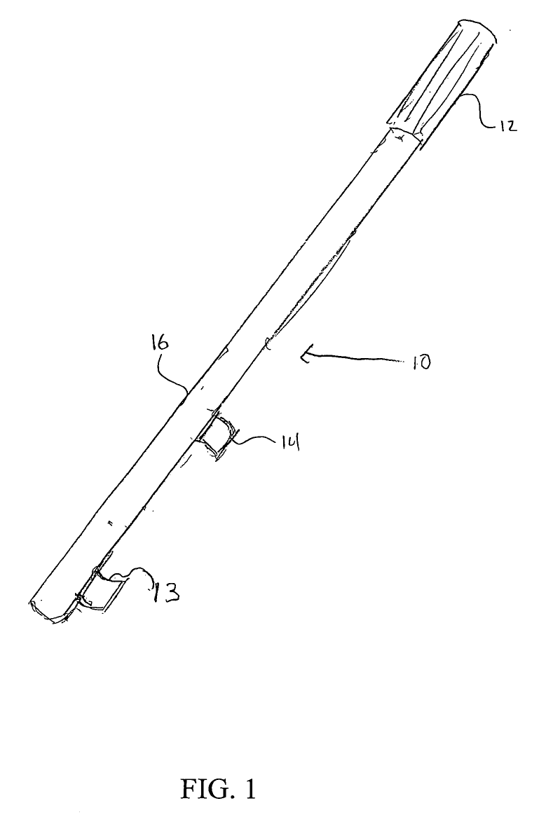

Referring now to the drawings, wherein like reference numerals designate corresponding structure throughout the views, and referring now to FIG. 1, wherein lug wrench extender 10 is shown.

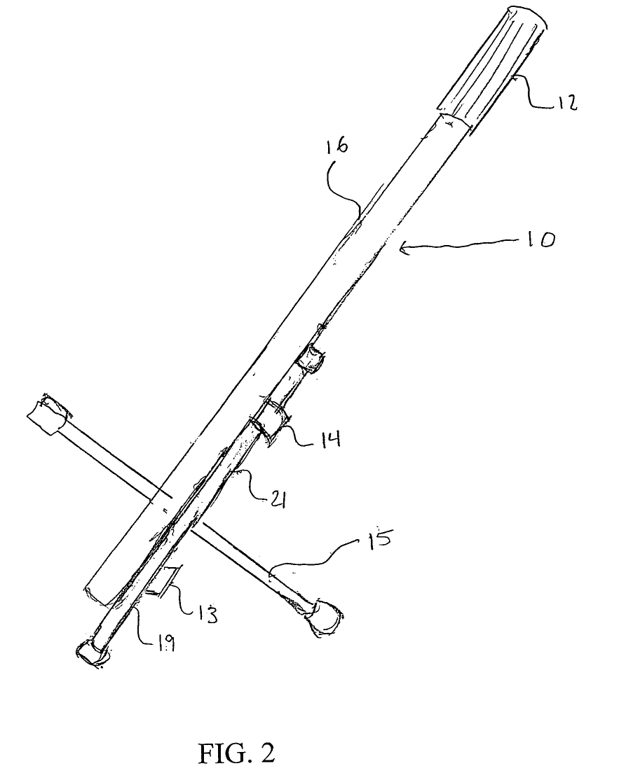

Wrench extender 10 has body 16, handle 12, first gripping member 13, and second gripping member 14. As shown in FIG. 2, wrench extender 10 is designed to be securably attached to cruciform shaped lug wrench 15. By attaching wrench extender 10 the overall length of lug wrench 15 is extended. This permits a person to apply more leverage when removing or attaching a lug nut to an automobile. The length and composition of wrench extender 10 provides additional weight to the end with handle 12. The length of wrench extender 10 is between 1 to 4 feet long, and preferably between 2 and ½ to 3 and ½ feet long. Body member 16 is between ¼ inch to 1 and ½ inch in diameter, and preferably between ½ inch to 1 inch in diameter. The spacing between first gripping member 13 and second gripping member 14 is sized to fit cruciform shaped lug wrench 15. The spacing is between about 6 to 14 inches, and preferably between 8 to 12 inches. Handle 12 is attached to end of body 16 and can be molded for easier grasping.

The spacing between first gripping member 13 and second gripping member 14 is important when fitting wrench extender 10 to cruciform shaped lug wrench 15. If the spacing is too small the cross bar portion of cruciform shaped lug wrench 15 will interfere with wrench extender 10. If the spacing between first gripping member 13 and second gripping member 14 is too large then there is a risk that one of the gripping members will interfere with the nut-removing portion of cruciform shaped lug wrench 15.

When used, wrench extender 10 is secured to the body of lug wrench 15 by placing gripping members 13 and 14 around the body. First gripping member 13 is positioned on first wrench half 19 of cruciform lug wrench 15 and second gripping member 14 is positioned on the second wrench half 21 of cruciform lug wrench 15. By placing wrench extender 10 on cruciform lug wrench 15 a person will have more leverage when removing lug nuts. This increased leverage enables people of lesser strength to remove even the tightest of nuts.

When wrench extender 10 is positioned on cruciform lug wrench 15, first gripping member 13 is positioned in such a way that the curve of the arc of first gripping member 13 is opposite of the curve of the arc of second gripping member 14. First gripping member 13 and second gripping member 14 are curved in opposite directions in order maximize the gripping of cruciform lug wrench 15 during usage of wrench extender 10. When looking at cruciform lug wrench 15 in FIG. 2, first gripping member 13 grips a bottom portion of first wrench half 19 and second gripping member 14 grips a top portion second wrench half 21. By having the gripping members curve in opposite directions, when wrench extender 10, shown in FIG. 2, is used, first gripping member 13 will exert force on first wrench half 19 in a direction opposite to the direction of force exerted by second gripping member 14 on second wrench half 21. The operation of the forces ensures the stability of wrench extender 10 on cruciform lug wrench 15 as well as enabling the operation of the increased leverage provided by wrench extender 10. It is to be understood though that the orientation of the gripping members with respect to the lug wrench will change depending on the orientation of the cruciform lug wrench 15. This arrangement of first gripping member 13 and second gripping member 14 enables wrench extender 10 to be removed and replaced with ease on cruciform lug wrench 15, when being used to either remove or replace lug nuts. During the removal or attachment of a lug nut, when a rotation brings handle 12 close to contact with the ground, wrench extender 10 can be easily removed and placed on the other half of cruciform lug wrench 15.

First gripping member 13 and second gripping member 14 are arc-shaped and may have an arc between 90° to a 240°. Preferably, the arc is between 120° to 210°. The arc shape of the gripping members both assists in the ease of removal and attachment of wrench extender 10 and also reinforces the securement of wrench extender 10 when in use. The arc shape conforms to the shape of the body of cruciform wrench 15 and enables the gripping members to be flush against the surface of cruciform wrench 15 when in use. When at rest, the curved shape of the gripping members permits easy removal and attachment of wrench extender 10. The length of the gripping members, taken along the length of body 16, shown as line A in FIG. 3, is preferably 2 inches, however it may be between 1 to 3 inches in length. The diameter of the gripping members, shown as line B in FIG. 3, is between 1 to 2 inches, and preferably between 1¼ inch to 1¾ inch. The thickness of the gripping members, shown as line C in FIG. 3, is between 1/32 to ½ of an inch, and preferably between 1/16 to ¼ of an inch.

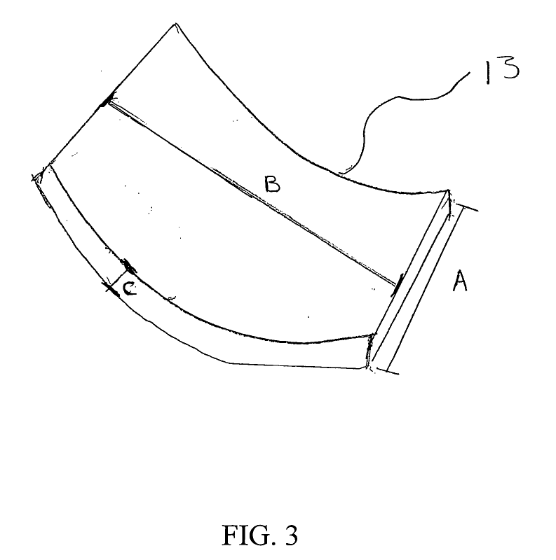

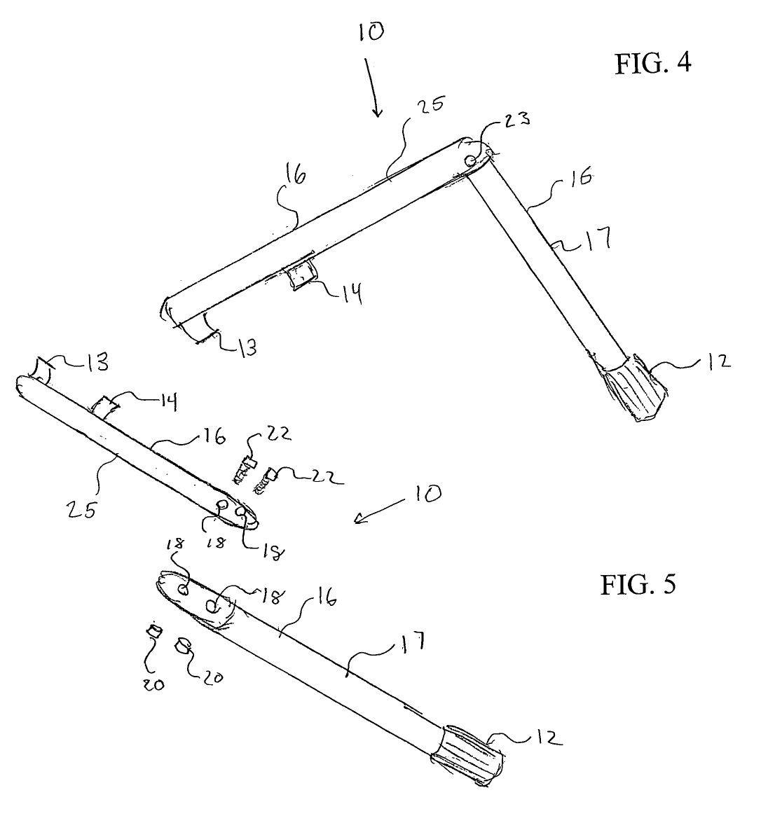

FIG. 4 shows an alternative embodiment of wrench extender 10 that is foldable for easier storage in the trunk of car, or some other storage device. In this embodiment of wrench extender 10, bottom body portion 17 and top body portion 25 are joined together by linking member 23. Linking member 23 enables bottom body portion 17 to be extended and firmly locked into place before wrench extender 10 is used for removing lug nuts. The ability to fold wrench extender 10 permits easier storage.

FIG. 5 shows an alternative embodiment of wrench extender 10 that can be separated into two halves and connected via screws 22 and bolts 20. Bottom body portion 17 has two holes 18 at one end for receiving screws 22. Screws 22 are passed through holes 18 on top body portion 25 and then through holes 18 on bottom body portion 17. Screws 22 are then secured in place with nuts 20. This embodiment permits wrench extender 10 to be separated into two halves for easier storage.

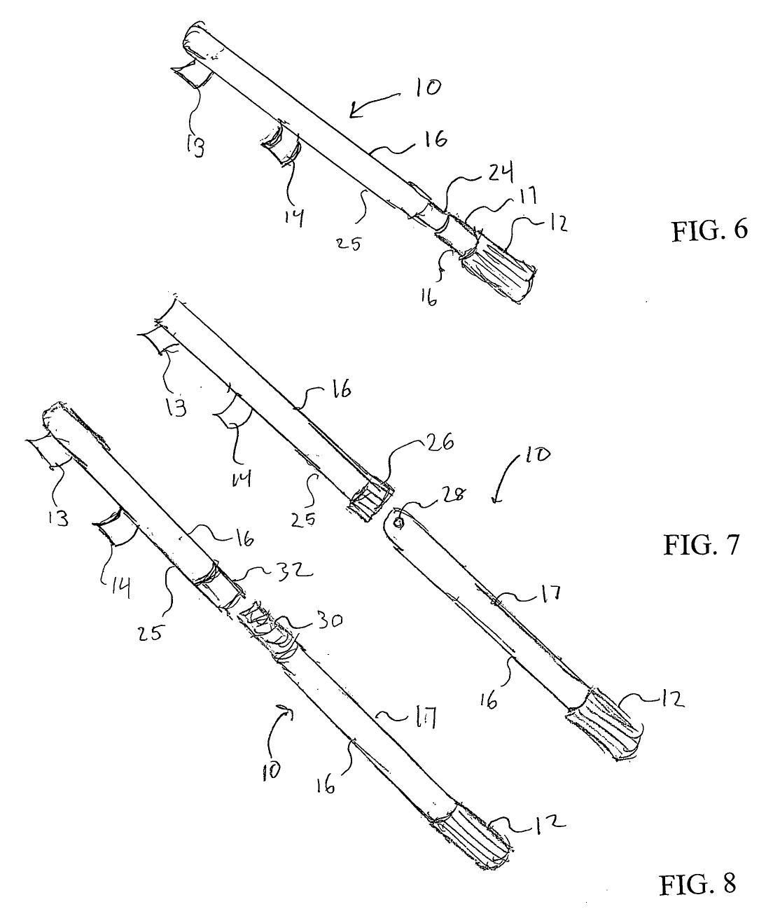

FIG. 6 shows an alternative embodiment of wrench extender 10 that has a telescopic portion 24 that enables wrench extender 10 to be compressed for easier storage. Telescopic portion 24 connects top body portion 17 and bottom body portion 25. When used, telescopic portion 24 unfolds thereby extending the length of wrench extender 10 enabling it to be attached to a lug wrench and used.

FIG. 7 shows an alternative embodiment of wrench extender 10 that can be separated into two halves and connected via a latch mechanism. The latch mechanism has an engagement portion 28 and a receiving portion 26. In order to connect top body portion 25 to bottom body portion 17, engagement portion 28 is depressed and bottom body portion 17 is inserted into top body portion 25. Upon insertion of bottom body portion 17, spring force, or some other biasing mechanism, in engagement portion 28 returns it to its original position, thereby engaging receiving portion 26.

FIG. 8 shows an alternative embodiment of wrench extender 10 that can be separated into two halves and connected via a screwing mechanism. Bottom body portion 17 has a threaded portion 30 that is screwed into thread engagement portion 32 of top body portion 25. This enables wrench extender 10 to be stored in an easier fashion and enables quick assembling of the device for use in removing lug nuts on automobiles.

FIG. 9 shows an alternative embodiment of wrench extender 10 with an angled handle 12. In this embodiment, body 16 has an angled portion 34 that places handle 12 in a more convenient location for gripping. Angled portion 34 may be incorporated into any of the above-mentioned embodiments.

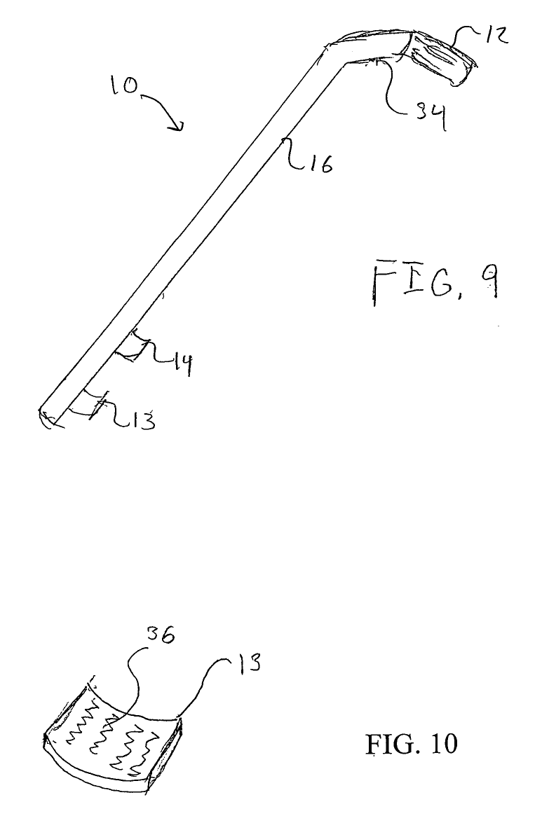

FIG. 10 shows an alternative embodiment of wrench extender 10 with a textured first gripping member 13. First gripping member 13 or second gripping member 14 may have a textured surface 36 that can be fashioned with grooves, a roughened surface area, an adhesive material, or grip tape. Textured surface 36 provides additional friction on the wrench surface when engaging a wrench. The additional friction assists in preventing accidental slippage when using wrench extender 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A wrench extender comprising:
a body member;
a first gripping member attached to said body member and curved in a first direction; and
a second gripping member attached to said body member and curved in a second direction, wherein said second direction is opposite of said first direction.

2. The wrench extender of claim 1, further comprising a handle.

3. The wrench extender of claim 2, wherein said handle is oriented at an angle with respect to said body member.

4. The wrench extender of claim 1, wherein said first gripping member comprises a surface area and said surface area is textured.

5. The wrench extender of claim 1, wherein said body member comprises a first portion and a second portion, and said first portion is connected to said second portion.

6. The wrench extender of claim 5, wherein said second portion is connected to said first portion via a thread mechanism.

7. The wrench extender of claim 5, wherein said second portion is connected to said first portion via a telescoping mechanism.

8. The wrench extender of claim 5, wherein said second portion is connected to said first portion via a latching mechanism.

9. The wrench extender of claim 5, wherein said second portion is connected to said first portion with a screw and a nut.

10. The wrench extender of claim 1, wherein said second portion is foldable with respect to said first portion.

11. The wrench extender of claim 1, wherein the length of the wrench extender is between 2 and ½ to 3 and ½ feet long.

12. The wrench extender of claim 1, wherein the spacing between first gripping member and second gripping member is between 6 to 14 inches.

13. The wrench extender of claim 1 wherein the spacing between first gripping member and second gripping member is between 8 to 12 inches.

14. A method for using a wrench extender comprising the steps of:
providing a wrench extender, wherein said wrench extender comprises:
a body member;
a first gripping member attached to said body member and curved in a first direction; and
a second gripping member attached to said body member and curved in a second direction, wherein said second direction is opposite of said first direction;
gripping a first portion of a cruciform wrench with said first gripping member;
gripping a second portion of said cruciform wrench with said second gripping member;
moving said wrench extender in either a clockwise or counterclockwise direction, wherein said step of moving said wrench extender moves said cruciform wrench.

15. The method of claim 14, wherein said wrench extender further comprises a handle.

16. The method of claim 15, wherein said handle is oriented at an angle with respect to said body member.

17. The method of claim 14, wherein said first gripping member comprises a surface area and said surface area is textured.

18. The method of claim 14, wherein said body member comprises a first portion and a second portion.

19. The method of claim 18, further comprising the step of connecting said first portion to said second portion.

20. The method of claim 19, wherein said step of connecting said first portion to said second portion comprises threading said first portion into said second portion.

21. The method of claim 19, wherein said step of connecting said first portion to said second portion comprises latching said first portion to said second portion.

22. The method of claim 19, wherein said step of connecting said first portion to said second portion comprises placing screws through holes in said first portion and said second portion and attaching nuts to said screws.

23. The method of claim 14, wherein said body member comprises a telescoping mechanism.

24. The method of claim 14, wherein said second portion is foldable with respect to said first portion.

25. The method of claim 24, further comprising the step of unfolding said wrench extender.
